(19) United States
(12) Patent Application Publication
(10) Pub. No.: US 2014/0032814 A1
(43) Pub. Date: Jan. 30, 2014

(54) HYBRID STORAGE DEVICE HAVING DISK CONTROLLER WITH HIGH-SPEED SERIAL PORT TO NON-VOLATILE MEMORY BRIDGE

(71) Applicants: Daniel S. Fisher, Dublin, CA (US); Jun Oie, Milpitas, CA (US); Jeffrey J. Holm, Eden Prairie, MN (US); Philip G. Brace, Pleasanton, CA (US); Daniel J. Dolan, JR., Cottage Grove, MN (US)

(72) Inventors: Daniel S. Fisher, Dublin, CA (US); Jun Oie, Milpitas, CA (US); Jeffrey J. Holm, Eden Prairie, MN (US); Philip G. Brace, Pleasanton, CA (US); Daniel J. Dolan, JR., Cottage Grove, MN (US)

(73) Assignee: LSI Corporation, Milpitas, CA (US)

(21) Appl. No.: 13/557,657

(22) Filed: Jul. 25, 2012

(51) Int. Cl. G06F 12/02

(52) U.S. Cl. CPC G06F 12/0246
USPC 711/103

(57) ABSTRACT

A hybrid storage device comprises at least one storage disk, a disk controller configured to control writing of data to and reading of data from the storage disk, a non-volatile electronic memory, and a bridge device coupled between the disk controller and the non-volatile electronic memory. The disk controller comprises a plurality of high-speed serial interfaces. In one embodiment, the high-speed serial interfaces include a first high-speed serial interface configured to interface the disk controller to a host device, and a second high-speed serial interface configured to interface the disk controller to the non-volatile memory via the bridge device. The non-volatile memory may comprise a flash memory, and the bridge device may comprise a flash controller. The disk controller may be implemented in the form of an SOC integrated circuit that is operative in a plurality of modes including a hybrid mode of operation and an enterprise mode of operation.

### BACKGROUND

Disk-based storage devices such as hard disk drives (HDDs) are used to provide non-volatile data storage in a wide variety of different types of data processing systems. A typical HDD comprises a spindle which holds one or more flat circular storage disks, also referred to as platters. Each storage disk comprises a substrate made from a non-magnetic material, such as aluminum or glass, which is coated with one or more thin layers of magnetic material. In operation, data is read from and written to tracks of the storage disk via respective read and write heads that are moved precisely across the disk surface by a positioning arm as the disk spins at high speed. The storage capacity of HDDs continues to increase, and HDDs that can store multiple terabytes (TB) of data are currently available.

HDDs often include a system-on-chip (SOC) to process data from a computer or other processing device into a suitable form to be written to the storage disk, and to transform signal waveforms read back from the storage disk into data for delivery to the computer. The SOC has extensive digital circuitry and has typically utilized advanced complementary metal-oxide-semiconductor (CMOS) technologies to meet cost and performance objectives. The SOC typically comprises a disk controller that may incorporate circuitry associated with read and write channels of the HDD. The HDD also generally includes a preamplifier that may be configured to interface the SOC to read and write heads used to read data from and write data to the storage disk.

As is well known, HDDs may be combined with other types of non-volatile memory to form hybrid storage devices. For example, a given such hybrid storage device may include a flash memory in addition to one or more HDDs.

### SUMMARY

Illustrative embodiments of the invention provide hybrid storage devices that include an HDD or other type of disk-based storage device as well as a non-volatile electronic memory such as a flash memory, with the hybrid storage device in a given such embodiment being configured to utilize high-speed serial interfaces to communicate, for example, with respective host and bridge devices associated with the hybrid storage device, where the bridge device provides access to the non-volatile electronic memory.

In one embodiment, a hybrid storage device comprises at least one storage disk, a disk controller configured to control writing of data to and reading of data from the storage disk, a non-volatile electronic memory, and a bridge device coupled between the disk controller and the non-volatile electronic memory. The disk controller comprises a plurality of high-speed serial interfaces, including a first high-speed serial interface configured to interface the disk controller to a host device, and a second high-speed serial interface configured to interface the disk controller to the non-volatile memory via the bridge device. Other configurations of the disk controller with at least one high-speed serial interface to the non-volatile memory via the bridge device are possible.

The non-volatile memory may comprise a flash memory, and more particularly a NAND flash memory that incorporates multi-level cell arrangements, and the bridge device may comprise a flash controller. Other types of non-volatile memories and associated bridge devices may be used in other embodiments.

By way of example, the disk controller may be implemented in the form of an SOC integrated circuit that is operative in a plurality of modes including a hybrid mode of operation and an enterprise mode of operation. In one possible hybrid mode of operation, the first high-speed serial interface interfaces the disk controller to the host device and the second high-speed serial interface interfaces the disk controller to the non-volatile memory via the bridge device. In one possible enterprise mode of operation, the first and second high-speed serial interfaces may be utilized to communicate with respective serial attached SCSI (SAS) storage devices, wherein SCSI denotes small computer system interface. A wide variety of other hybrid or enterprise modes may be supported in a given embodiment, including an enterprise mode involving other types of serial attached storage devices, such as single-port serial advanced technology attachment (SATA) HDDs.

It should be emphasized that references above to SCSI and SATA storage devices are illustrative examples only, and numerous other types of storage devices may be used in a given hybrid or enterprise mode, including, for example, peripheral component interconnect express (PCIe) storage devices.

One or more of the embodiments of the invention provide significant improvements in hybrid storage devices. For example, the disclosed arrangements allow the same SOC to be used in both hybrid storage devices as well as in non-hybrid storage applications such as enterprise SAS arrangements. Accordingly, the SOC may be operative in multiple modes, including both a hybrid mode of operation and an enterprise mode of operation. This increases the versatility of the SOC while also reducing the cost and complexity associated with implementation of hybrid storage devices.

### BRIEF DESCRIPTION OF THE DRAWINGS

FIG. 1 is a block diagram of a hybrid storage device in an illustrative embodiment of the invention.

FIG. 2 illustrates one possible implementation of the hybrid storage device of FIG. 1.

FIG. 3 shows a virtual storage system incorporating a plurality of storage devices of the type shown in FIG. 1.

### DETAILED DESCRIPTION

Embodiments of the invention will be illustrated herein in conjunction with exemplary hybrid storage devices and associated controllers, SOCs and other components. It should be understood, however, that these and other embodiments of the invention are more generally applicable to any storage device or associated controller or SOC in which improved configuration flexibility is desired. Additional embodiments may be implemented using components other than those specifically shown and described in conjunction with the illustrative embodiments.

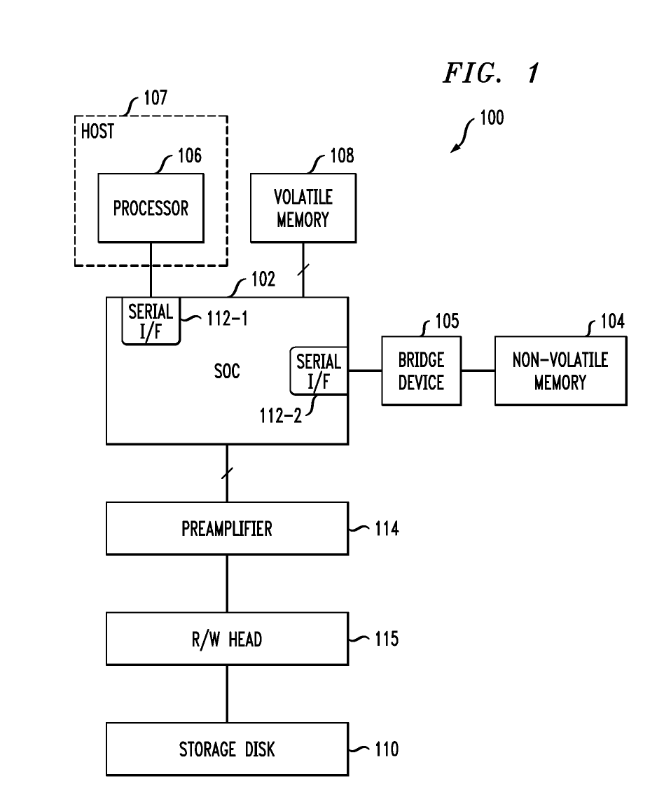

FIG. 1 shows a hybrid storage device 100 in accordance with an illustrative embodiment of the invention. The storage device 100 comprises an SOC integrated circuit 102 that communicates with a non-volatile electronic memory 104 such as a NAND flash memory via a bridge device 105 which may illustratively comprise a flash controller integrated circuit. The SOC 102 also communicates with a processor 106. The processor 106 is assumed to be part of or otherwise associated with a host device 107, such as a computer or server which in some embodiments may be viewed as being external to the storage device.

The SOC 102 is coupled to volatile memory 108, which in the present embodiment is assumed to comprise electronic memory such as random access memory (RAM), but may also incorporate read-only memory (ROM), or other types of volatile memory, in any combination. As a more particular example, the memory 108 in the present embodiment may comprise double data rate (DDR) synchronous dynamic RAM (SDRAM), although a wide variety of other types of memory may be used in other embodiments.

The memory 108 may be viewed as an example of what is more generally referred to herein as a “computer-readable storage medium.” Such a memory can be used, for example, to store executable code that when executed within the storage device 100 controls certain functionality of the storage device.

The hybrid storage device 100 also comprises at least one storage disk 110. The storage device 100 in this embodiment may more specifically comprise an HDD that includes storage disk 110. The storage disk 110 has a storage surface coated with one or more magnetic materials that are capable of storing data bits in the form of respective groups of media grains oriented in a common magnetization direction (e.g., up or down). The storage disk 110 may be connected to a spindle that is driven by a spindle motor, although neither of these elements is explicitly shown in the figure. The storage surface of the storage disk 110 may comprise a plurality of concentric tracks, with each track being subdivided into a plurality of sectors each of which is capable of storing a block of data for subsequent retrieval. The storage disk 110 may also be assumed to include a timing pattern formed on its storage surface. Such a timing pattern may comprise one or more sets of servo address marks (SAMs) or other types of servo marks formed in particular sectors in a conventional manner.

The SOC 102 comprises multiple high-speed serial interfaces 112-1 and 112-2, each of which may comprise a serial advanced technology attachment (SATA) interface. The first high-speed serial interface 112-1 is configured to interface the SOC 102 to the processor 106 of host device 107, and the second high-speed serial interface 112-2 is configured to interface the SOC 102 to the non-volatile memory 104 via the bridge device 105. The term “high-speed” as used herein is intended to refer to data rates over approximately 1 gigabit/second (1 Gb/sec). For example, the two serial SATA interfaces may each operate at data rates of about 6 Gb/sec in one possible implementation.

The SOC 102 in the present embodiment is configured to operate as a disk controller and is therefore coupled via a preamplifier 114 to a read/write head 115. The disk controller illustratively implemented by SOC 102 is configured to control writing of data to and reading of data from the storage disk 110 via the preamplifier 114 and read/write head 115. The SOC 102 may therefore be viewed as an example of what is more generally referred to herein as a “disk controller.” In other embodiments, such a disk controller may be configured using multiple integrated circuits and possibly other components, rather than using a single SOC integrated circuit as in the present embodiment.

The preamplifier 114 may comprise, for example, driver circuitry used to provide write signals to the read/write head 115. Such driver circuitry may include multi-sided driver circuitry, possibly including, for example, an X side and a Y side, each comprising both high side and low side drivers, where the X and Y sides are driven on opposite write cycles. Numerous alternative arrangements of driver circuitry are possible in other embodiments.

The read/write head 115 may be mounted on a positioning arm that in conjunction with an electromagnetic actuator controls the position of the read/write head over the magnetic surface of the storage disk 110, although such arm and actuator components are not shown in the figure.

The use of separate high-speed serial interfaces to communicate with the non-volatile memory 104 and the host 107 allows the SOC 102 to be configured in a cost-efficient manner to support multiple modes of operation. For example, in the arrangement illustrated in FIG. 1, the SOC 102 may be viewed as being configured in a hybrid mode of operation, in which the first high-speed serial interface 112-1 interfaces the SOC 102 to the host device 107 and the second high-speed serial interface 112-2 interfaces the SOC 102 to the non-volatile memory 104 via the bridge device 105.

The SOC may also be configurable in other operating modes, such as an enterprise mode of operation in which the first and second high-speed serial interfaces are both utilized to communicate with respective serial attached SCSI (SAS) storage devices, where SCSI denotes Small Computer System Interface, Such an operating mode is typical of an enterprise environment, where the SOC is more likely to be interfaced to multiple SAS storage devices than to a host device and a flash memory. Other types and combinations of operating modes may be used in other embodiments.

It should be noted that the different operating modes referred to above may refer to operating modes of a single storage device, or alternatively may refer to operation of SOC 102 in one of the operating modes in one storage device and the other operating mode in another storage device. Thus, for example, some implementations of a given storage device that incorporates SOC 102 may be configured to operate only in the hybrid mode, while other such storage devices are configured to operate in other modes, such as the enterprise mode described previously.

The particular hybrid configuration of SOC 102 as shown in FIG. 1 allows the SOC to be manufactured in a very cost-efficient manner, by avoiding the need to incorporate into the SOC a separate parallel interface that might otherwise be needed for communicating with the bridge device 105 in a hybrid mode of operation. Although such a parallel interface can be useful in interfacing an SOC to a bridge device, the parallel interface may not be useful in other modes, such as the above-noted enterprise mode, in which the SOC is required to communicate with respective SAS storage devices over respective high-speed serial interfaces. Inclusion of such a parallel interface solely for use in a hybrid mode of operation therefore represents an undesirable increase in the cost and complexity of the SOC 102. Another drawback associated with use of a parallel interface of the type described above is that it may support only limited types of flash memory, such as single-level cell (SLC) flash memory, and therefore provide no support for multi-level cell (MLC) flash memory.

The FIG. 1 embodiment allows the same SOC 102 that is utilized in a hybrid mode of operation to also be used in an enterprise mode of operation, without any need for redesigning the SOC itself, and therefore without any additional manufacturing cost, chip complexity, or power requirements. Also, the parallel interface generally has a high pin count, such as a pin count of 18, as compared to a pin count of 6 for a SATA serial interface. Avoiding the need for the parallel interface can therefore significantly reduce the pin count of the SOC 102, by 12 pins in the previous example. Moreover, this serial interface arrangement can support both SLC and MLC flash memory.

It is to be appreciated that, although FIG. 1 shows an embodiment of the invention with only one instance of each of SOC 102, non-volatile memory 104, bridge device 105, host 107 volatile memory 108, storage disk 110, preamplifier 114 and read/write head 115, this is by way of illustrative example only, and alternative embodiments of the invention may comprise multiple instances of one or more of these or other storage device components. For example, one such alternative embodiment may comprise multiple storage disks attached to the same spindle so all such disks rotate at the same speed, and multiple read/write heads and associated positioning arms coupled to one or more actuators.

A given read/write head as that term is broadly used herein may be implemented in the form of a combination of separate read and write heads. More particularly, the term “read/write” as used herein is intended to be construed broadly as read and/or write, such that a read/write head may comprise a read head only, a write head only, a single head used for both reading and writing, or a combination of separate read and write heads. A given read/write head such as read/write head 115 may therefore include both a read head and a write head. Such heads may comprise, for example, write heads with wrap-around or side-shielded main poles, or any other types of heads suitable for recording and/or reading data on a storage disk. Read/write head 115 when performing read operations or write operations may be referred to as simply a read head or a write head, respectively.

Also, the storage device 100 as illustrated in FIG. 1 may include other elements in addition to or in place of those specifically shown, including one or more elements of a type commonly found in a conventional implementation of such a storage device.

For example, the storage device may incorporate one or more interfaces implemented as Advanced eXtensible Interface (AXI) fabrics, described in greater detail in, for example, the Advanced Microcontroller Bus Architecture (AMBA) AXI v2.0 Specification, which is incorporated by reference herein. Such a bus may be used to support communications between various system components.

These and other conventional elements, being well understood by those skilled in the art, are not described in detail herein. It should therefore be understood that the particular arrangement of elements shown in FIG. 1 is presented by way of illustrative example only. Those skilled in the art will recognize that a wide variety of other storage device configurations may be used in implementing embodiments of the invention.

An example of an SOC integrated circuit that may be modified for use in embodiments of the invention is disclosed in U.S. Pat. No. 7,872,825, entitled “Data Storage Drive with Reduced Power Consumption,” which is commonly assigned herewith and incorporated by reference herein.

Other types of integrated circuits that may be used to implement processor, memory or other storage device components of a given embodiment include, for example, a microprocessor, digital signal processor (DSP), application-specific integrated circuit (ASIC), field-programmable gate array (FPGA) or other integrated circuit device.

In an embodiment comprising an integrated circuit implementation, multiple integrated circuit dies may be formed in a repeated pattern on a surface of a wafer. Each such die may include a disk controller or associated SOC as described herein, and may include other structures or circuits. The dies are cut or diced from the wafer, then packaged as integrated circuits. One skilled in the art would know how to dice wafers and package dies to produce packaged integrated circuits. Integrated circuits so manufactured are considered embodiments of the invention.

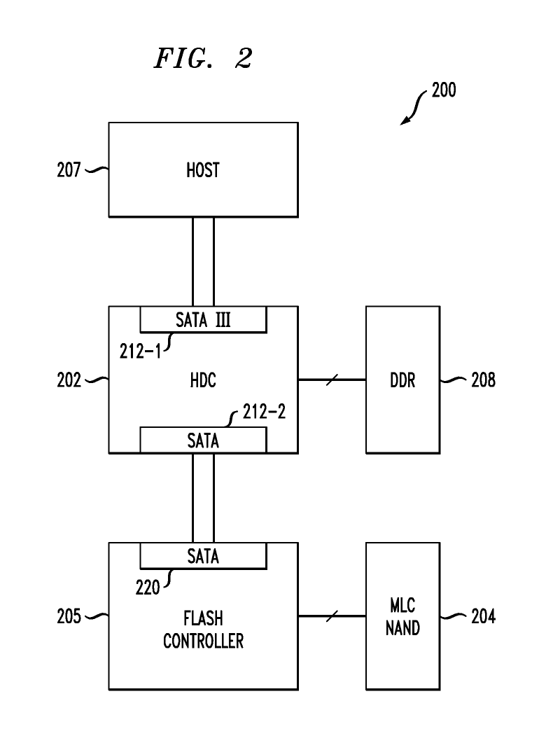

FIG. 2 shows one possible implementation of a portion of the hybrid storage device of FIG. 1. In this embodiment, hybrid storage device 200 comprises a hard disk controller (HDC) 202 coupled to an MLC NAND flash memory 204 via a flash controller 205. The HDC 202 is also coupled to a host device 207 and to DDR memory 208. Not shown in this figure are additional disk-related components of the storage device 200 such as a preamplifier, read/write head and storage disk. The HDC 202 comprises a first SATA serial interface 212-1 over which the HDC communicates with host device 207. The SATA serial interface 212-1 in this embodiment is more particularly implemented as a SATA III serial interface. The HDC 202 further comprises a second SATA interface 212-2 over which the HDC communicates with flash controller 205, utilizing SATA interface 220 of the flash controller 205. As in the FIG. 1 embodiment, an SOC integrated circuit may be used to implement the HDC 202. The SATA serial interfaces may each operate, for example, at a data rate of 6 Gb/sec, although a wide variety of other data rates may be used.

Although illustrated using an MLC NAND flash memory 204 in the figure, other types of flash memory, or more generally non-volatile memory, may be used in place of the MLC NAND flash memory. For example, as previously indicated herein, SLC non-volatile memories may be used.

It is to be appreciated that the particular storage device arrangements shown in FIGS. 1 and 2 are presented by way of illustrative example only, and other embodiments of the invention may utilize other types and arrangements of elements for configuring an SOC or other disk controller to support multiple modes of operation, including at least one hybrid mode of operation, as disclosed herein.

For example, a given SOC in an embodiment of the invention may support other types of enterprise modes of operation, such as an enterprise mode in which one or more single-port SATA HDDs are connected to the SOC. Numerous other types of modes can additionally or alternatively be supported, including modes which involve interconnection with one or more USB devices.

In addition, references herein to particular types of storage devices such as SCSI and SATA devices are made by way of illustrative example only. Other embodiments can utilize other types of storage devices, including, for example, peripheral component interconnect express (PCIe) drives, in any combination.

Also, HDDs implemented in embodiments of the invention can utilize any of a wide variety of different recording techniques, including, for example, shingled magnetic recording (SMR), bit-patterned media (BPM), heat-assisted magnetic recording (HAMR) and microwave-assisted magnetic recording (MAMR).

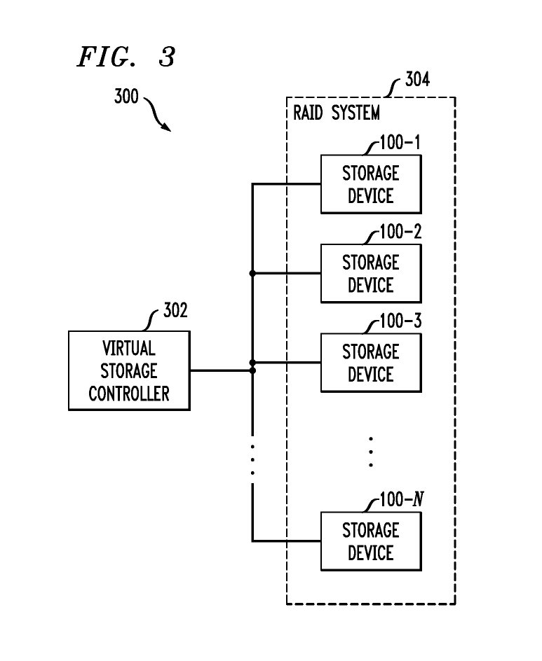

Multiple instances of storage device 100 may be incorporated into a virtual storage system 300 as illustrated in FIG. 3. The virtual storage system 300, also referred to as a storage virtualization system, illustratively comprises a virtual storage controller 302 coupled to a RAID system 304, where RAID denotes Redundant Array of Independent Disks. The RAID system more specifically comprises N distinct storage devices denoted 100-1, 100-2, . . . 100-N, one or more of which are assumed to be configured as a hybrid storage device of the type previously described in conjunction with FIG. 1 or FIG. 2. These and other virtual storage systems comprising hybrid storage devices of the type disclosed herein are considered embodiments of the invention. A given host device such as host device 107 of FIG. 1 or host device 207 of FIG. 2 may also be an element of a virtual storage system, and may incorporate the virtual storage controller 302.

Again, it should be emphasized that the above-described embodiments of the invention are intended to be illustrative only. For example, other embodiments can use different types and arrangements of disk controllers, volatile and non-volatile memories, bridge devices, host devices and other storage device elements for implementing the described functionality. Also, the particular manner in which a given disk controller is configured to communicate with host and bridge devices over respective high-speed serial interfaces may be varied in other embodiments. These and numerous other alternative embodiments within the scope of the following claims will be apparent to those skilled in the art.

What is claimed is:

1. A storage device comprising:
at least one storage disk;
a disk controller configured to control writing of data to and reading of data from the storage disk;
a non-volatile electronic memory; and
a bridge device coupled between the disk controller and the non-volatile electronic memory;
wherein the disk controller comprises a plurality of high-speed serial interfaces; and
wherein a given one of the high-speed serial interfaces is configured to interface the disk controller to the non-volatile memory via the bridge device.

2. The storage device of claim 1 wherein:
a first one of the high-speed serial interfaces is configured to interface the disk controller to a host device; and
a second one of the high-speed serial interfaces is configured to interface the disk controller to the non-volatile memory via the bridge device.

3. The storage device of claim 1 wherein the non-volatile memory comprises a flash memory.

4. The storage device of claim 1 wherein the non-volatile memory comprises a least one of a single-level cell non-volatile memory and a multi-level cell non-volatile memory.

5. The storage device of claim 3 wherein the bridge device comprises a flash controller.

6. The storage device of claim 1 wherein at least one of the high-speed interfaces comprises a serial advanced technology attachment (SATA) interface.

7. The storage device of claim 2 wherein the disk controller comprises an SOC integrated circuit.

8. The storage device of claim 7 wherein the SOC integrated circuit is operative in a plurality of modes including a hybrid mode of operation.

9. The storage device of claim 8 wherein in the hybrid mode of operation of the SOC integrated circuit the first high-speed serial interface interfaces the disk controller to the host device and the second high-speed serial interface interfaces the disk controller to the non-volatile memory via the bridge device.

10. The storage device of claim 8 wherein the SOC integrated circuit is operative in an enterprise mode of operation in which the first and second high-speed serial interfaces are utilized to communicate with respective serial attached storage devices.

11. A virtual storage system comprising the storage device of claim 1.

12. The virtual storage system of claim 11 wherein the virtual storage system comprises a redundant array of independent disks.

13. A method comprising the steps of:
writing data to and reading data from a storage disk using a disk controller; and
interfacing the disk controller to a non-volatile electronic memory via a bridge device using a high-speed serial interface of the disk controller.

14. The method of claim 13 further including the step of interfacing the disk controller to a host device using another high-speed serial interface of the disk controller.

15. The method of claim 13 further including the step of operating an SOC integrated circuit comprising the disk controller in a plurality of modes including a hybrid mode of operation.

16. The method of claim 15 wherein in the hybrid mode of operation of the SOC integrated circuit a first high-speed serial interface interfaces the disk controller to a host device and a second high-speed serial interface interfaces the disk controller to the non-volatile memory via the bridge device.

17. The method of claim 15 further including the step of operating the SOC integrated circuit in an enterprise mode of operation in which first and second high-speed serial interfaces are utilized to communicate with respective serial attached storage devices.

18. A non-transitory computer-readable storage medium having embodied therein executable code that when executed causes a storage device to perform the steps of the method of claim 13.

19. An apparatus comprising:
an integrated circuit comprising a disk controller configured to control writing of data to and reading of data from a storage disk;
wherein the integrated circuit comprises a plurality of high-speed serial interfaces; and
wherein a given one of the high-speed serial interfaces is configured to interface the disk controller to a non-volatile memory via a bridge device.

20. The apparatus of claim 19 wherein another one of the high-speed serial interfaces is configured to interface the disk controller to a host device.
